(19) United States
(12) Patent Application Publication
(10) Pub. No.: US 2009/0213751 A1
(43) Pub. Date: Aug. 27, 2009

(54) Optimum Selection of a Communication Network in the Location Area of a Terminal

(75) Inventors: Dirk Langefeld, Langenfeld (DE); Rainer Liebhart, Muenchen (DE); Martin Oettl, Weilheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Nokia Siemens Networks GmbH & KG

(21) Appl. No.: 11/886,893

(22) PCT Filed: Mar. 9, 2006
(86) PCT No.: PCT/EP2006/060598

§ 371 Date: Feb. 18, 2009

(30) Foreign Application Priority Data
Mar. 24, 2005 (DE) 102005013908.6

(51) Int. Cl. H04L 12/28; H04W 84/02

(52) U.S. Cl. 370/254; 370/338

(57) ABSTRACT

In a method of selecting a communication network and connecting a mobile station into a communication network in a coverage area of which it is located, a mobile station is temporarily connected to a network unit of a first communication network, and sends a request relating to at least one second communication network to be used for communication via the network unit from the mobile station to a further network unit. After verifying the request by the farther network unit at least one response message containing at least one item of information is sent to the mobile station. The mobile station connects to a communication network depending on the at least one item of information received.

The invention relates to a method and a mobile station for selection of a communication network and for connecting a mobile station into a communication network within the coverage area of which it is located.

3GPP services will in future be offered over a very wide variety of IP-based access networks. Examples of such networks are so-called Interworking WLANs (I-WLAN, Interworking Wireless Local Area Network) which are connected to mobile radio networks and are standardized in 3GPP. Other examples are WIMAX and xDSL access networks, with the intention being with WIMAX especially to have a similar architecture for connection to mobile radio as with WLAN. One of the most significant problems in conjunction with wireless access networks such as WLAN is the network search. In such cases both searching for an optimum access network (a number of WLAN networks can be operated in one hotspot for example) and also searching during roaming for an optimum mobile radio network or further intermediate networks which can be reached via the access network is a problem to be resolved.

If the terminal has sought out an I-WLAN, this can be connected to a number of mobile networks. These communication networks must be notified to the terminal by the I-WLAN so that the terminal can seek out a preferred mobile radio network. The lists of the preferred networks are either stored in the terminal or on the USIM card. Especially when roaming, in which case the I-WLAN has no direct connection to the home mobile radio network of the subscriber, it is for important for the terminal to select a preferred roaming partner of its home network in order to save connection and roaming costs and be able to make use of as many services as possible.

The assumption is made in the previous 3GPP standard that the terminal is looking for all available WLANs, connects in turn in each WLAN and attempts to authenticate itself with its home mobile radio network (automatic selection procedure). If the selected WLAN is not an I-WLAN, this attempt fails, and the terminal must connect to the next available WLAN. If the WLAN network is an I-WLAN in accordance with the 3GPP standard, but is not directly connected to the home mobile radio network of the subscriber (roaming), the I-WLAN sends the terminal a list of the mobile radio networks to which it is directly connected. The terminal then continues its search for I-WLAN networks. At the end of the search process, from the information obtained, the terminal uses preconfigured lists of preferred I-WLANs and mobile radio networks to select an I-WLAN and mobile radio network to which it connects. Optionally a method is also described in the standard for how an I-WLAN can communicate its interworking capability and the connected mobile radio networks to the terminal during its search for WLAN networks. Since this information (so-called SSID, Service Set Id) is sent out before connection into the WLAN network by the WLAN radio stations using a broadcast (multi-transmission method), this would lead to a simplification of the search procedure. Since WLAN 802.11 technology is not standardized by 3GPP but by IEEE, 3GPP cannot mandatorily prescribe the structures of the SSID in the WLAN broadcast. In addition the SSID field has a restricted length (32 bytes), so that it may also be possible for not all information to be stored there about all connected mobile radio networks. The SSID is also configured by the WLAN network operator and can thus be incorrect or misleading.

The search procedures currently specified are thus very tedious and require many resources in the terminal.

The 3GPP standard has so far offered only the optional possibility of sending out information within the WLAN-SSID information about the interworking capability of a WLAN. The connected mobile radio networks can only identify the terminal once it has connected to all available I-WLANs and has received the corresponding data from them. In this case the optimum access network and the preferred mobile radio network are defined by statically preconfigured lists on the (U)SIM card or the terminal itself. These lists are either stored once by the home network operator on the(U)SIM or can be manually supplemented and prioritized by the user. This method of operation is inflexible and expensive for the network operator, for the subscriber it is difficult and inconvenient.

The object of the invention is to propose a simple and an efficient option by which a terminal can select a communication network.

The inventive object is achieved in each case by the subject matter of the independent claims. Further developments of the invention are specified in the subclaims.

A core of the invention is to be seen as making the selection of a communication network, for example an access network, a WLAN-network, a cellular mobile radio network, an IP network or a further communication network more flexible and faster by using a further network unit, for example a registration unit, a database, a memory unit etc. for example in the HPLMN network (home network). Alternatively this further network unit can also be operated in the Internet or in another communication network for example and accept data over all possible communication networks. This naturally requires ongoing discussions between the network operators and a body which then operates this further network unit. This further network unit could be called an “IP Access Register”. In this case the terminal searches as previously for example for an access network with I-WLAN capabilities in a hotspot (the discrimination between I-WLAN and “normal” WLAN networks can for example be speeded up by specific SSID values). If any given I-WLAN network has now been found, the search is ended by the terminal and the terminal connects temporarily into this I-WLAN. The I-WLAN allows the terminal in this state to send a request via a network unit of the I-WLAN to the further network unit, for example in its home network. This can be achieved for example by specific port filters in the access routers or by using virtual LAN networks. Such a request can be executed with an SIP, H.323, HTTP, for security reasons HTTPS or another (secure) (signaling) protocol, with the server authentication being sufficient in this case. In principle it is also possible for the terminal to connect to any given WLAN and for example to reach the further network unit in the home network via the Internet for example. A network unit, for example an HTTP proxy server, in the I-WLAN or for example any given connected cellular mobile radio network uses origin information in such cases such as the MCC (Mobile Country Code) and the MNC (Mobile Network Code) or x/y location coordinates in the request message. As an alternative or in addition the terminal could also perform this function if it has this information available to it (e.g. using positioning methods via GPS (Global Positioning System)). The terminal or the application on the terminal can additionally send data or requests such as the bandwidths required for example or the security of the access network to the further network unit, which can be taken into account by the further network unit in selecting the communication networks.

The further network unit receives this request and determines from the origin data and the additional requirements of the terminal the optimum access network or communication network in the hotspot (coverage area of the communication network), the preferred visited communication network VPLMN and where necessary further intermediate networks or communication networks, and sends this information, in the form of the SSID and MNC/MCC for example, in a response message back to the terminal. In this case a great advantage lies in the fact that this information, by contrast with the data which is available pre-configured in the terminal, can be flexibly adapted in accordance with country, location, tariff, network loading and time.

After receiving the data, the terminal connects into a communication network depending on the information received. The terminal, for example a mobile computer, a computer, a mobile radio station, a mobile organizer etc., could also interrogate the further network unit at periodic intervals or after the network configuration has changed (e.g. by changing the location) in order if possible to obtain more favorable connection co-ordinates. Authentication messages are sent in accordance with the 3GPP standard via the visited mobile network which has been predetermined by the home network operator. This obviates the need for a reconciliation between the available mobile networks with those stored on the (U)SIM card. Existing (U)SIM cards can even continue to be used. After successful authentication in the home network the terminal is in a position for example to establish a connection into this network via the visited mobile radio network and use the services in the home network.

This invention disclosure describes a method for how a central further network unit, for example a register unit, may be used to enable access to IP-based radio technologies such as WLAN to be simplified and optimized for mobile radio operators and subscribers. The selection procedure is thus accelerated and the use of resources in the terminal is reduced. The described register unit also offers the opportunity of storing a further data which can be relevant for the terminal or the communication network for an optimized roaming or handover. These IP-based access networks can in such cases be specified by 3GPP or can quite generally simply be connected via a router to the 3GPP core network.

The invention is explained in greater detail on the basis of an exemplary embodiment shown in a figure. The figures show

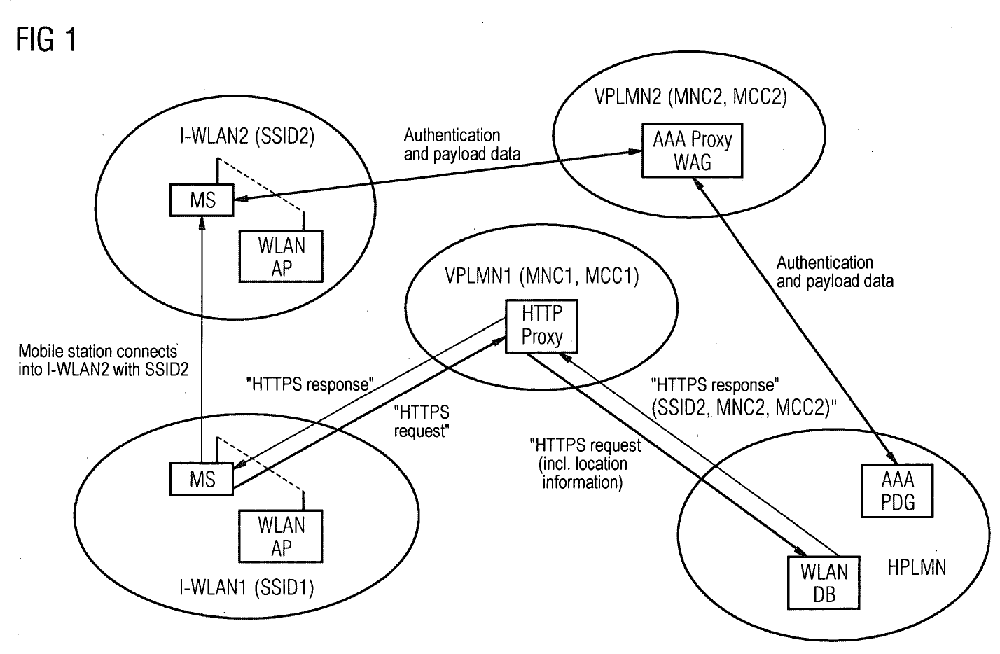

FIG. 1 the method in accordance with the invention with reference to a simplified system architecture,

FIG. 2 an inventive mobile station.

FIG. 1 shows how a mobile station, for example a mobile radio terminal, a mobile computer, a mobile organizer, a computer etc., in a hotspot can connect itself temporarily into a communication network VPLMN 1 via the access network I-WLAN1 and send a request by means of the HTTPS protocol via a network unit HTTP Proxy of the communication network VPLMN 1 to a further network unit WLAN DB of the home network HPLMN of the mobile station MS. The network unit HTTP Proxy can in this case be a proxy server, a network unit of the access network I-WLAN 1 etc. The request could be supplemented by the network unit HTTP Proxy or also by the mobile station MS with at least one item of information such as the country code, the network code of the communication network currently being used, the location information relating to the current location of the mobile station MS etc. The mobile station MS in addition to the request, could also insert data or requests such as the bandwidth required for example, the security requirements for the communication network etc. The further network unit WLAN DB, for example a register a unit, a database, a memory unit etc in the home network WLAN DB checks the request and sends a response with the least one item of information, for example the SSID identity of the preferred access network I-WLAN2 and the mobile country code or mobile Network Code MNC2/MCC2 of the preferred (visited) communication network VPLMN2. Temporary in this case means that the mobile station only connects into the communication network VPLMN 1 via the access network I-WLAN1 to be able to make the request to the further network unit. After receiving the at least one item of information contained in the response, the mobile station MS, depending on the information received, connects into the communication network VPLMN2 (for example via the authentication network unit AAA Proxy WAG) via the access network I-WLAN2 (for example via the WLAN radio access point WLAN AP), authenticates itself in respect of the home network HPLMN (for example at the authentication network unit AAA PDG) in accordance with the 3GPP standard and thereafter to sets up a connection to execute a communication to the home network HPLMN, in order to use specific subscription services there for example. A cellular mobile radio network, a WLAN network, an IP network, an I-WLAN network etc. can be used as a communication network or access network. The mobile station could, because of a network configuration or also at periodic or even no-periodic intervals, send such a request relating to at least one communication network to be used for the communication to the further network unit WLAN DB and thus have the opportunity of always selecting the optimum communication network for communication.

FIG. 2 shows a mobile station MS for executing the inventive method with a receive unit E, a transmit unit S and a processing unit V.

1. A method of selecting a communication network and connecting a mobile station into a communication network in a coverage area of which it is located, comprising:
temporarily connecting a mobile station to a network unit of a first communication network,
sending a request relating to at least one second communication network to be used for communication via the network unit from the mobile station to a further network unit,
after verifying the request by the further network unit sending at least one response message containing at least one item of information to the mobile station, and
connecting to a communication network by the mobile station depending on the at least one item of information received.

2. The method of claim 1, further comprising
adding by the network unit at least one item of information data to the request from the mobile station.

3. The method of claim 2, wherein
an item of information data is at least one of a country code, a network code of the communication network to which the mobile station is temporarily connected, and an item of position information relating to a current location of the mobile station.

4. The method of claim 1, further comprising
adding by the mobile station data relating to at least one of a bandwidth needed by the mobile station and security requirements for the communication network to the request.

5. The method of claim 1, wherein
the SSID number, the network code and/or the country code of the communication network to be used is used in the response message as information relating to the at least one second communication network to be used for communication.

6. The method of claim 1, wherein
the network unit is one of a proxy server and an I-WLAN network.

7. The method of claim 1, wherein
the further network unit is one of a register unit, a memory unit and a database.

8. The method of claim 7, wherein
the further network unit is one of a network unit of an IP network and a WLAN network.

9. The method of claim 7, wherein
the further network unit is a network unit of a home network of the mobile station.

10. The method of claim 1, wherein
the HTTP protocol, the HTTPS protocol, the SIP protocol and/or the H.323 protocol are used as the signaling protocol.

11. The method of claim 1, further comprising
sending by the mobile station, as a result of a change to a network configuration, to the further network unit a request relating to the communication network to be used for a communication.

12. The method of claim 1, further comprising
sending at periodic intervals by the mobile station a request to the further network unit relating to the communication network to be used for a communication.

13. The method of claim 1, wherein
one of a mobile radio terminal, a mobile computer, a computer and a mobile organizer is used as the mobile station.

14. The method of claim 1, wherein
at least one of a WLAN network, an IP network and a cellular mobile radio network is used as the communication network.

15. A mobile station configured to select a communication network and to connect to the communication network in a coverage area of which said mobile station is located, comprising:
a receive unit and a transmit unit to execute the communication,
a processing unit for temporary connection to a network unit of a first communication network, for sending a request relating to at least one second communication network to be used for a communication via the network unit to a further network unit and for connecting into a communication network, depending on at least one item of information sent by the at least one further network unit to the mobile station in a response message.

16. A system for selecting a communication network and connecting to the communication network in a coverage area of which a mobile station is located, comprising:
a mobile station for temporary connection to a network unit of a first communication network and for sending a request relating to at least one second communication network to be used for a communication via the network unit to a further network unit,
wherein the further network unit is configured to verify the request and to send at least one item of information contained in a response message to the mobile station, and
wherein the mobile station is configured to connect to a communication network depending on the at least one item of information received.
